(19) United States
(12) Patent Application Publication
(10) Pub. No.: US 2017/0269716 A1
(43) Pub. Date: Sep. 21, 2017

(54) TOUCHSCREEN

(71) Applicant: BERNECKER + RAINER INDUSTRIE-ELEKTRONIK Ges.m.b.H., Eggelsberg (AT)

(72) Inventor: Guenter SCHUSTER, Ranshofen (AT)

(73) Assignee: BERNECKER + RAINER INDUSTRIE-ELEKTRONIK Ges.m.b.H., Eggelsberg (AT)

(21) Appl. No.: 15/460,847

(22) Filed: Mar. 16, 2017

(30) Foreign Application Priority Data
Mar. 17, 2016 (AT) A50225/2016

(51) Int. Cl. G06F 3/0362; G06F 3/041; G06F 3/044

(52) U.S. Cl. CPC G06F 3/0362; G06F 3/044; G06F 3/0416; G06F 2203/04104

(57) ABSTRACT

The invention relates to a projected capacitive touchscreen (1) having an image-generating layer (2), a sensor layer (3) and a touch layer (4) which has an external surface (5) and an internal surface (6). The sensor layer (3) is arranged on the side of the internal surface (6) of the touch layer (4) and, when the external surface (5) is touched with a touch organ (8), the touch (7) can be measured and evaluated by the sensor layer (3) through the thickness of the touch layer (4). At least one guide track (9) for the touch organ (8) is machined out of the touch layer (4) from the external surface (5) of the touch layer (4) in the region of the sensor layer (3) and the image-generating layer (2).

### CROSS-REFERENCE TO RELATED APPLICATIONS

The present application claims priority under 35 U.S.C. §119(a) of Austrian Patent Application No. A50225/2016 filed Mar. 17, 2016, the disclosure of which is expressly incorporated by reference herein in its entirety.

### BACKGROUND OF THE INVENTION

1. Field of the Invention

The invention relates to a touchscreen having an image-generating layer, a sensor layer and a touch layer which has an external surface and an internal surface, wherein the sensor layer is arranged on the side of the internal surface of the touch layer and wherein, when the external surface is touched with a touch organ, the touch can be measured and evaluated by the sensor layer through the thickness of the touch layer. Further, the invention relates to an operating panel for a machine controller.

2. Discussion of Background Information

Touchscreens are increasingly being used for operating panels for the control of machines. This is becoming possible, particularly due to the development of so-called projected capacitive touchscreens (or PCAP touchscreens), as these can be built with a thick and stable front glass which is also suitable for use in industrial environments and protects the sensitive electronics of the operating panel. In practice, the thickness of the front glass is restricted to a maximum of approximately 5-6 mm due to the sensitivity of the PCAP sensor layers traditionally used; however, sensor layers which can even overcome glass thicknesses of up to 20 mm have already been developed.

The flexible usability of touchscreens is advantageous when they are used for operating panels, as the type and arrangement of the switching and/or display elements on the touchscreen can be configured practically at will. However, the absence of haptic properties has been shown to be disadvantageous in practice, as the external surface of the touch layer is smooth and flat. In general, the touch layer is made of glass or a comparable transparent material which has no haptic identifying features of any kind.

### SUMMARY OF THE EMBODIMENTS

The present invention is based on the object of providing a touchscreen of the kind mentioned in the introduction, in particular a projected capacitive touchscreen, which overcomes the disadvantages of the prior art and enables haptic operability without substantially adversely affecting the advantages of the flexible configurability of the user interface, for example in an operating panel.

This and further objectives are achieved by a touchscreen of the kind mentioned in the introduction, with which at least one guide track for the touch organ is machined out of the touch layer from the external surface of the touch layer in the region of the sensor layer and the image-generating layer. Known PCAP touch sensors and displays from any manufacturer can be used for the sensor layer and/or the image-generating layer. In the conventional manner, the PCAP touch sensor can be evaluated by a touch controller and the data processed further in an arithmetic unit.

As a human finger is normally used as the touch organ, a width between 0.7 cm and 2 cm, preferably between 1 cm and 1.5 cm, and particularly preferably between 1.2 cm and 1.3 cm, and a maximum depth between 0.5 mm and 1 mm, preferably between 0.7 mm and 0.9 mm, have been shown to be particularly advantageous for the guide track with regard to operability as this satisfies most ergonomic conditions.

In an advantageous manner, the thickness of the touch layer can be 3 mm or more. This enables the production of high-quality, stable and unsusceptible touchscreens, wherein adequate stability is guaranteed even in the regions in which the thickness of the touch layer is restricted due to guide tracks. A conventional front glass pane, which is preferably optically glued to the sensor layer over the whole surface, can be used as a material for the touch layer. The guide tracks are ground into the front glass pane on the side of the external surface.

In an advantageous embodiment, the guide track can have a circular or oval progression, wherein the maximum outside diameter of the round or oval guide track corresponds to the dimensions of a rotary dial which can be actuated with one or two fingers. This requires minimal readjustment for a user who is used to conventional rotary dials. In conjunction with a three-dimensional representation of the rotary dial, a slightly oval design of the guide track can improve the visual impression and operability.

Preferably, in a further advantageous embodiment of the invention, a haptically tangible surface structure can be arranged, at least in parts, in the guide track. This provides a haptic feedback for the user when using the switching element associated with the guide track. For example, the surface structure in the guide track can be formed or etched to be partially or completely matt, or, for example, it can have transverse grooves or a structure pattern over the surface which, as well as the haptic tangibleness, also constitutes a visual design feature.

In a further advantageous embodiment of the invention, the touch layer can be partially back-printed on its internal surface. This allows the production of touchscreens with partially unchangeable design features (in the printed regions) which can then be supplemented by variable regions in which the display is defined by the image-generating layer.

The invention furthermore relates to an operating panel for a machine controller, wherein the operating panel has a touchscreen of the kind described above as a user interface.

### BRIEF DESCRIPTION OF THE DRAWINGS

The present invention is explained in more detail below with reference to FIGS. 1 to 3, which show advantageous embodiments of the invention in an exemplary, schematic and non-restricting form. In the drawing

FIG. 1 shows a schematic sectional view through a touchscreen according to the invention,

FIG. 2 shows a diagrammatic representation of a touchscreen shown partially sectioned, and

FIG. 3 shows an operating panel for a machine controller.

### DETAILED DESCRIPTION OF THE EMBODIMENTS

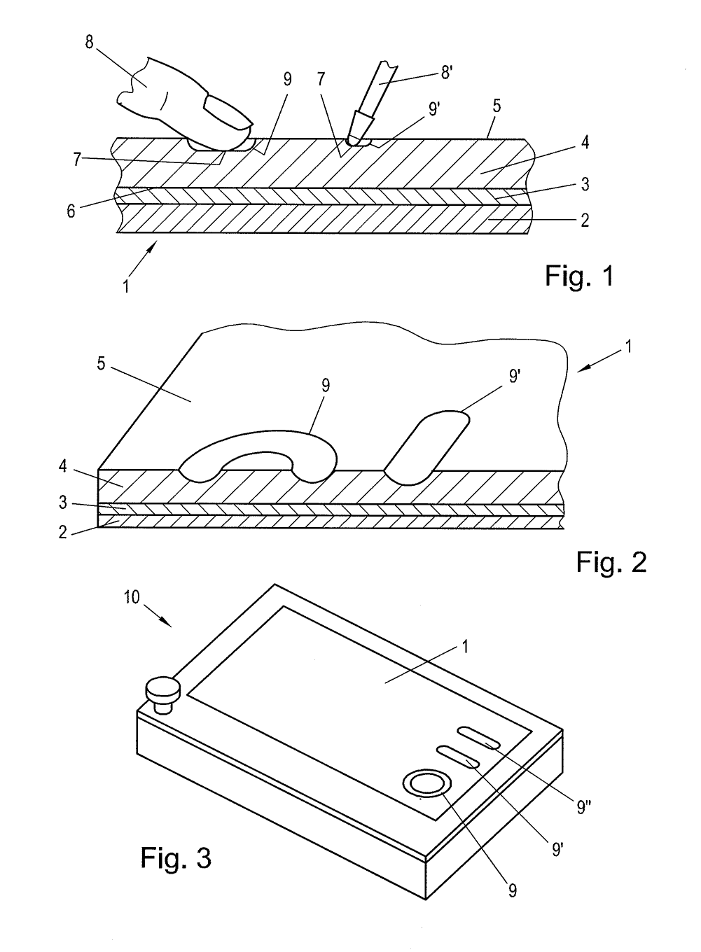

FIG. 1 shows the essential elements of a touchscreen 1 according to the invention which is designed as a projected capacitive touchscreen. The layer structure of such a touchscreen 1 has at least one touch layer 4, a sensor layer 3 and an image-generating layer 2. It is known in the specialist field that further layers can also be included in the structure, for example polarization or filter layers. Such layers can also be used in the touchscreen according to the invention; however, for simplicity, they are not shown in FIG. 1. Other generally known design and mounting elements, such as retaining frames, housings, fixing elements or adhesive layers, for example, have also been omitted from the diagram for reasons of clarity. However, such elements are readily known to the person skilled in the art.

The touch layer 4 is the outermost layer of the touchscreen 1 and it consists in general of hardened and particularly break-resistant special glass. When used with mobile devices, in which the weight plays a particular role, the touch layer is usually made as thin as possible, for example between 0.5 and 0.7 mm, as a result of which these touchscreens often have a significant tendency to break. However, for industrial applications, as an operating panel for example, a considerably higher resistance to breakage is required, wherein the weight only plays a significant role when the operating panel is to be portable. For permanently mounted operating panels, it is preferred that the touch layer 4 be designed as stably (and therefore, in general, as thick) as possible, wherein the maximum thickness is limited by the measuring capability of the sensor layer 3.

Touchscreens, in which the touch layer 4 has a free external surface 5, which is touched by the touch organ 8, and an internal surface 6, which is connected to the sensor layer 3, are described as projected capacitive. This means that a touch 7 by a touch organ 8 is measured through the touch layer 4. When the touchscreen 1 is manufactured, the touch layer 4 is generally glued to the surface of the sensor layer 3, wherein a transparent or clear adhesive is used in order not to adversely affect the display of the image-generating layer 2 which is arranged beneath the (likewise transparent) sensor layer 3.

In general, the sensor layer 3 consists of a transparent film which is glued or laminated to the internal surface 6 of the touch layer 4. The image-generating layer 2 is arranged on the rear of the sensor layer, wherein all common types of thin-film displays can be used, for example TFT, LCD or OLED image-generating layers.

As is generally common, the touchscreen 1 is used by touching 7 the external surface 5 with a touch organ 8, usually one (or more) finger (touch organ 8 in FIG. 1) or a stylus (touch organ 8′ in FIG. 1). Elements displayed with the image-generating layer 2 can be tapped individually with the touch organ 8, which can be interpreted as clicking a switching element or actuating a pushbutton for example. Operating the touchscreen 1 can, however, also include more complex gestures, for example with one finger or several fingers.

For special applications, for example for operating panels for machine controllers, the internal surface 6 of the touch layer 4 can be printed or back-printed, for instance to provide a continuous and unchanging structure for the operating panel. Instead of this print, a separate layer with the print can, of course, also be arranged between the touch layer 4 and the sensor layer 3 or between the sensor layer 3 and the image-generating layer 2.

Guide tracks 9, 9′ are provided in certain places in the external surface 5 of the touch layer 4. These guide tracks 9, 9′ are preferably milled into the external surface 5 during manufacture, and they have a width and depth which provides a guide for the touch organ 8, 8′.

When the touchscreen is to be operated with a finger (touch organ 8), a width between 0.7 cm and 2 cm, preferably approximately 1.2 cm-1.3 cm, with a maximum depth between 0.5 mm and 1 mm, preferably approximately 0.7 mm to 0.9 mm, have been shown to be advantageous. However, the dimensions of the guide tracks 9, 9′ can also be optimized for other touch organs, for example the touch organ 8′ in FIG. 1 which is in the form of a stylus.

Two particularly preferred embodiments of the guide tracks 9, 9′, namely one with a circular progression (guide track 9) and one with a straight progression (guide track 9′), are shown in FIG. 2 in a partially sectioned perspective view of the touchscreen 1.

The straight guide track 9′ can be used, for example, for implementing slide controllers. On the other hand, the round guide track 9 can advantageously be used for implementing control dials.

In particular, the integration of control dials in touchscreen operating concepts is problematic with regard to operability, as “blind” actuation of the control dial without accidentally leaving the region of the control dial is virtually impossible without haptic guide aids. For this reason, in conventional operating panels, control dials are still arranged as a separate element next to the actual touchscreen. However, this has the disadvantage that the control dial then always has the same design and a different presentation is not possible.

With the help of the concept according to the invention, the characteristics of controllers, e.g. dials or linear controllers, can be designed and animatedly displayed at will, wherein only the position of the controller on the touchscreen 1 is specified by the position of the guide track 9. It is also advantageous that the region(s) provided by the guide tracks 9, 9′ for the linear controller(s) and/or dial(s) can be used for a control element, but this is not absolutely necessary. As a result, depending on the operating concept and/or machine status, different control interfaces, which use the guide tracks 9, 9′ in different ways, can be provided and integrated or not into the concept.

FIG. 3 shows by way of example an operating panel 10, for example for a machine controller, which is provided with the touchscreen 1 according to the invention. The touchscreen 1 has a circular guide track 9 and two straight guide tracks 9′, 9″. The circular guide track 9 can be used in conjunction with a control dial, for example, and the straight guide tracks 9′, 9″can accordingly be used for slide controllers for example. For this purpose, an appropriate representation of a slide controller or dial only has to be displayed behind the respective guide tracks 9, 9′, 9″, and the actuation of the controllers is measured and evaluated with the touchscreen in a known manner. A circular movement of the touch organ 8 in the circumferential groove of the guide track 9 can be interpreted, for example, as “rotation” of the control dial displayed beneath this guide track 9. Accordingly, a swipe along the guide tracks 9′, 9″ can be interpreted as sliding a slide controller, which can be displayed accordingly on the touchscreen. Alternatively or in addition, the setting of the dial or slide controller can be displayed as a value on the touchscreen, for example as a percentage figure.

With the help of the teaching from this description, the person skilled in the art can provide a touchscreen with numerous differently designed guide tracks, wherein the number, form and arrangement of the guide tracks on the touchscreen surface can be designed at will in accordance with the particular requirements. As well as circular, oval and straight forms, other closed or open designs can also be implemented. For example, curved, arc-shaped, angled and/or wavy or zigzag guide tracks can be used if this is beneficial for the particular purpose.

### LISTING OF REFERENCE NUMERALS:

Touchscreen 1
Image-generating layer 2
Sensor layer 3
Touch layer 4
External surface 5
Internal surface 6
Touches 7
Touch organ 8
Guide track 9
Operating panel 10

1. A touchscreen (1) having an image-generating layer (2), a sensor layer (3) and a touch layer (4) which has an external surface (5) and an internal surface (6), wherein the sensor layer (3) is arranged on the side of the internal surface (6) of the touch layer (4) and wherein, when the external surface (5) is touched with a touch organ (8), the touch (7) can be measured and evaluated by the sensor layer (3) through the thickness of the touch layer (4), wherein, at least one guide track (9) for the touch organ (8) is machined out of the touch layer (4) from the external surface (5) of the touch layer (4) in the region of the sensor layer (3) and the image-generating layer (2).

2. The touchscreen (1) according to claim 1, wherein the guide track (9) has a width between 0.7 cm and 2 cm, preferably between 1 cm and 1.5 cm, and particularly preferably between 1.2 cm and 1.3 cm, and a maximum depth between 0.5 mm and 1 mm, preferably between 0.7 mm and 0.9 mm.

3. The touchscreen (1) according to claim 1, wherein the thickness of the touch layer (4) is 3 mm or more.

4. The touchscreen (1) according to claim 1, wherein the guide track (9) has a circular or oval progression, wherein the maximum outside diameter of the round or oval guide track (9) corresponds to the dimensions of a rotary dial which can be actuated with one or two fingers.

5. The touchscreen (1) according to claim 1, wherein a haptically tangible surface structure is arranged, at least in parts, in the guide track (9).

6. The touchscreen (1) according to claim 1, wherein the touch layer (4) is partially back-printed on its internal surface (6).

7. An operating panel (10) for a machine controller, wherein the operating panel (10) has a touchscreen (1) according to claim 1 as a user interface.
